(19) United States
(12) Patent Application Publication
(10) Pub. No.: US 2011/0093468 A1
(43) Pub. Date: Apr. 21, 2011

(54) SYSTEM AND METHOD FOR IMPROVING STORAGE AND RETREIVAL OF DOCUMENTS

(75) Inventors: Betty B. McAlvany, Chicago, IL (US); Michael Herman, Andover, NJ (US); Tanya Marie Mahan, Stratford, CT (US); Kathleen T. Laken, Bloomingdale, IL (US); Mary Jo Gove, Irvine, CA (US)

(73) Assignee: Pitney Bowes Inc., Stamford, CT (US)

(21) Appl. No.: 12/581,448

(22) Filed: Oct. 19, 2009

(51) Int. Cl. G06F 17/30

(52) U.S. Cl. 707/741; 707/736; 707/758; 707/E17.002

(57) ABSTRACT

A system and method for enhancing the storage and retrieval of documents includes employing information about documents filed in a retained document filing arrangement and information about document processing channels. The information is used in the system and method to implement a document processing channel that enhances the further storage and retrieval of document filed in the retained document filing arrangement. A controller computer may be in communications with sensors connected to the retained document filing arrangement to provided attribute data for retained documents. The document processing channels can employ scanning, digitizing and indexing.

### BACKGROUND OF THE INVENTION

The life cycle of documents such as mail and other media is complex and can be costly. The usage of various documents from creation to document destruction varies greatly depending on the type of document and the type of use over the life of the document. The exponential growth in documents created within corporations and other organizations requiring long term retention, coupled with the frequency of access needed to the information has created many challenges for organizations. These include identifying and properly determining the appropriate storage and disposition of information and records. The multiple factors requiring assessment to allow for an informed decision on the best cost benefit analysis are complex and extensive. Various costs are associated with the manner in which retained documents are stored and retrieved. The expenses are not limited to direct costs of the document life process but also the impact on the operations of the organization. The cost to an organization to be unable timely retrieve information from stored documents can offset the cost of any particular storage arrangement.

The appropriate storage and disposition of documents can vary over time as the information ages. Depending on the type of information, more frequent access or less frequent access may be needed to the documents which contain the information. For example, in long term clinical studies spanning decades, more frequent access may be needed to original documents containing data when the studies are concluding. On the other hand, access to equipment service information may no longer be required after the equipment is scraped. Moreover, the nature of appropriate storage and disposition of documents can vary as organizations change focus or mission and also as organizations downsizing or expanding facilities which may contained stored documents.

### SUMMARY OF THE INVENTION

When it comes to enhancing the storage, retrieval and disposition of documents, a need exits in assessing the true cost impact of retention of various physical storage arrangements and various digitally converted document storage arrangements over the life of the record.

A system and method are provided which improve the implementation of document processing channels for the appropriate storage, retrieval and disposition of retained documents.

A system for enhancing the storage and retrieval of documents embodying the present invention includes a retained document filing arrangement to receive documents to be retained. The retained document filing arrangement has sensors configured to detect sensed attributes of documents filed in the retained document filing arrangement. A controller computer is in communications with the retained document filing arrangement sensors and is configured to receive sensed attributes of documents filed in the retained document filing arrangement. The controller computer includes a memory storage device configured to receive and store attribute data regarding attributes of documents filed in the retained document filing arrangement. The memory storage device further includes data correlating particular filed document attributes corresponding to stored attributes of one or more document processing channels. The controller computer is programmed to compare filed document attributes by processing filed document sensed attributes and stored document processing channel attributes to determine similarities of sensed document attributes and stored document processing channel attributes. The memory storage device for the controller computer includes document processing channel recommendations corresponding to the filed documents in the retained document filing arrangement and the controller computer is programmed to present those document processing channel recommendations to a user based on filed document sensed attributes and stored document processing channel attributes.

A computer implemented method of enhancing the storage and retrieval of documents embodying the present invention includes the steps of inputting information about documents filed in a retained document filing arrangement. The information including data regarding the volume of documents in the retained document filing arrangement and frequency of access to the documents filed in the retained document filing arrangement. Inputting information about document processing channels, the information including data relating to document preparation for filing, filed document maintenance, filed document access, filed document retrieval and filed document destruction. Comparing the input information about documents filed in the retained document filing arrangement and the input information about document processing channels to determine similarities of input information about filed documents and input information about document processing channels. The comparing step includes correlating document processing channel attributes with filed document attributes, and further includes recommending a document processing channel to a user whereby a document processing channel implementation is facilitated that enhances the further storage and retrieval of documents filed in the retained document filing arrangement.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts in the various figures.

FIG. 1 shows steps for creating and processing documents (mail and other media) through the life cycle of the documents, for the purpose of analyzing the storage, retrieval and disposal of documents for alternate document processing channels;

FIG. 2 shows data inputs organized for use in the in the flow chart of FIG. 3 and the system shown in FIG. 4;

FIG. 3 is a flow chart of the analysis of the alternate document processing channels useful in controlling the processing of documents in accordance with the present invention; and,

FIG. 4 depicts a system for image ingestion and indexing workflow that can embody the present invention and constitutes a sample document processing channel.

### DETAILED DESCRIPTION OF THE PRESENT INVENTION

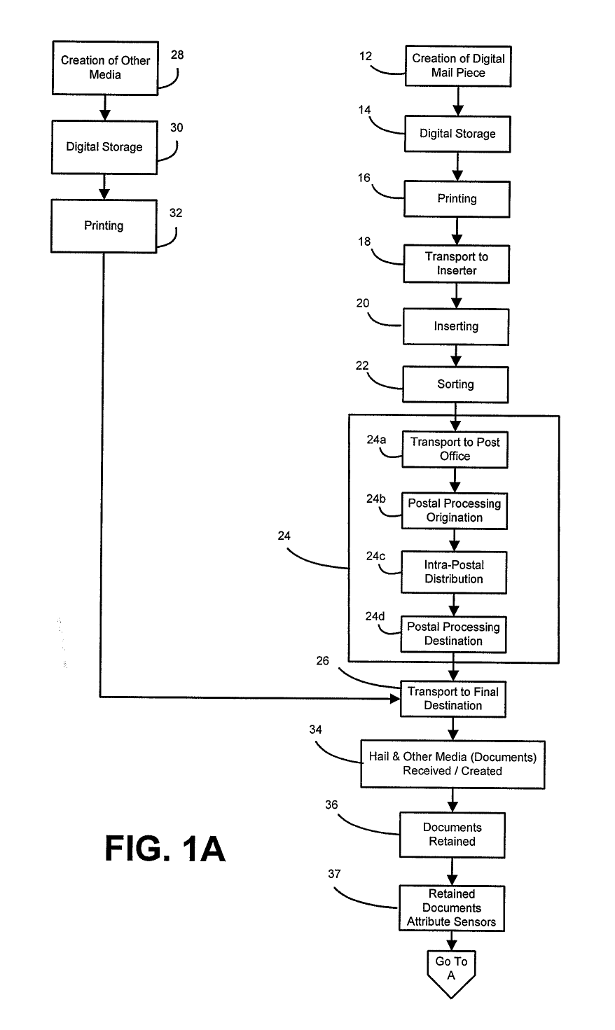

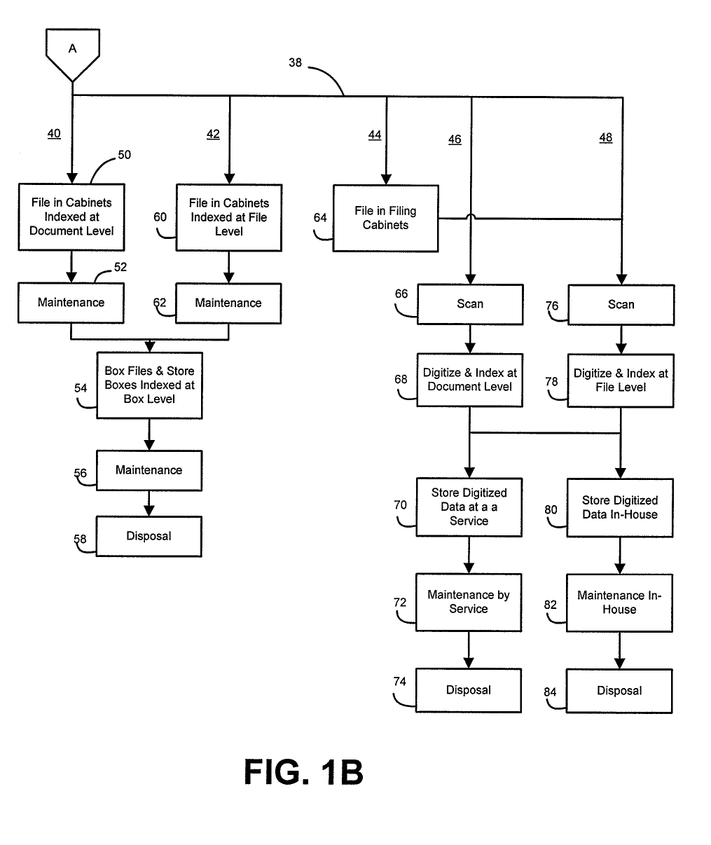

The system shown in the FIGS. 1-4 for improving storage and retrieval of documents is a physical and electronic records asset management system that controls the document processing channel implementation to enhance the effectiveness of storage retrieval and destruction of information contained in documents. Document processing channels are systems for storing documents, retrieving documents or the information contained therein, maintain the stored documents and destroying the documents when no longer needed. The documents can be in physical form or in electronic form. A document processing channel can involve both physically stored and electronically stored documents. The various document processing channels can include, for example: a document processing channel of indexing, packaging and storing physical documents; a document processing channel of scanning, ingesting and storing images of documents; a document processing channel of partially scanning, ingesting and storing the documents such as document file folders and relating the scanned information to index, packaged and stored physical documents; or dividing a group of documents for processing among different document processing channels.

By obtaining and inputting certain data such as by means of sensors, the most efficient and effective document processing channel can be implemented. The sensors can be located in many different positions, locations and points in a retained document filing arrangement where retained documents are stored before they are moved into a document processing channel for further longer term retention. Different types and forms of filing arrangements for retained documents can be employed such as file cabinets, file shelves and the like, with varying implementation. The sensors can be place on file room doors, on file cabinets, on the file cabinet drawers or shelves, and on the actual files and documents, to provide accurate data as to the size, that is, the volume of documents, and the frequency of access to file areas, file cabinets and actual files and documents. The sensors provide sensed attribute data about the stored retained documents and document files and access to information to help determine and control the document processing channel implementation.

The system enables a determination, for example, estimating how much it will cost to scan and index at the file folder level, to scan and index files at the document level, or to retain physical storage of files. The system enables a determination of costs associated with physical onsite and offsite as well as electronic conversion and management of files to provide the first year as well as the lifecycle cost estimates for retention and the implementation of the most efficient document processing channel for a given set of retained documents for which document attribute data is obtained.

In determining document channel attributes that involve scanning, the process and costs include the following activities and associated costs. Customer pre-processing preparation cost for the time it will take to prepare a file for scanning which can include activities such as filling out a coversheet with indexing information, boxing the files and removing files from file jackets. Document preparation cost to prepare the file pages for scanning. Document scan cost to scan each page in a file. Index cost the price to index the files. Optical character recognition (OCR) cost to include OCR of the pages being scanned. Annual retrieval cost to retrieve a file from the document repository server. Hardcopy destruction cost to destroy the hardcopy files once they are digitized. Document extraction and pull cost to pull documents before or during processing and send the hardcopy document, scan on demand, or a facsimile of the document back to the document owner/user for emergency purposes should documents be needed before they are digitized. File Transfer Protocol (FTP) charge to upload documents, for example, per megabyte (MB), to a designated server. Online storage cost to store documents temporarily online for a defined period of time until they are successfully delivered to the document owner/user in a digitized format. Retention costs to the document owner/user to retain and store the digitized files for their lifecycle. Data maintenance cost for annual maintenance and server cost for the document repository

A number of activities for this document processing channel involving scanning are one time processes that do not occur annually. These activities and associated costs include but are not limited to: preparing the files for scanning or warehousing; scanning the files; indexing the files; OCR of the files during scan; destruction of the hardcopy files; packaging of hardcopy files for warehousing; and, pickup and transport to the warehouse. Moreover, the nature of the scanning can vary. The scanning may be bursted file scanning or bulk scanning. Bursted file scanning is document level scanning and indexing. The files are broken into multiple sections as allocated in the files and documents resulting in multiple PDF or TIFF files. Bulk scanning is scanning the files in bulk where the entire file will be scanned into one PDF or TIFF file.

In determining document channel attributes that involve hardcopy offsite retention, the process and costs include the following activities and associated costs. Storage preparation costs to prepare records for warehousing. Packaging cost of labels, boxes, tape and other required materials. Pickup and transport cost for packaged documents. Per trip charge for warehouse trips including any fuel surcharge. New box entry fee to add new boxes to the warehouse. Rush retrieval cost to retrieve a box by rush order. Permanently out of storage the cost to permanently remove a stored box from the storage database inventory. Destruction fee for destruction of stored boxes. Monthly storage cost for warehouse storage.

In determining document channel attributes that involve hardcopy onsite retention, the process and costs include the following activities and associated costs. Real estate costs, such as cost per square foot, to house and access physical records. Equipment cost of file storage such as filing cabinets or shelves. The costs can include the cost associated with sensors such as software hardware and labor to index, track and manage the document files. Estimated fully burdened labor cost for retrievals and maintenance of files multiplied by the estimated time. Estimated time to maintain files onsite annually.

The attribute data of retained documents that can be detected and obtained by the various sensors associated with the retained document filing arrangement. The specific attribute information of the retained documents can include the following attributes that can be modified manually based on past experience or the document owner/user estimates as to future use. Where the number and placement of sensors do not enable all the desired retained document attributes to be sensed, the missing information can be entered manually either based on estimate or actual measurement. The sensed attributes can include all or some of the following. Total number of document pages or files (document volume), that is, the number of physical pages to be imaged based on what is presently onsite as retained documents. Number of file folders containing the documents under review. Number of documents in the collection in the retained document files where documents contain multiple pages. Number of in-process extractions, that is, number of retrievals that will occur while the documents are away at the imaging center and in the process of being digitized based on sensed prior usage. The retention period of these files in years based on sensed prior usage and/or legally mandated retention requirements if available. Percentage of retained document files moved to offsite warehouse storage on a yearly basis. Expected number of file retrievals per year based on prior sensed usage.

Reference is now made to FIG. 1. Documents are created and go through a life cycle which includes the creation, document use and document destruction. How the document is used will impact on the costs of the various alternative document processing channels herein after described. The document creation can include the creation of a digital mail piece at block 12 the digital storage of the mail piece at block 14 and the printing thereof at block 16. The printed document may be transported to an inserter at 18 and inserted into a mail piece at block 20. The document can thereafter be sorted at block 22 and go through various processes in connection with postal processing as shown generally in box 24. These may include transport to the post office at block 24a, postal processing at an originating postal facility at block 24b, intra-postal distribution at block 24c and postal processing at a postal facility near the destination at block 24d. The processing with the postal operation results in the transport of the mail piece to the final destination at block 26.

The creation of other media is depicted at block 28 and can involve digital storage at block 30 and printing at block 32. It should be recognized that other forms of media creation can be employed which result in a transport to a final destination at block 26, such as facsimile, email, IM, etc. The creation of mail and media can be enhanced by employing different methods and systems. For example, the carbon footprint of mail can be improved by the method and system disclosed in US Patent Application of Sussmeier ET AL for METHOD AND SYSTEM FOR IMPROVING CARBON FOOTPRINT OF MAIL, Ser. No. 12/334,935, filed Dec. 15, 2008 and assigned to Pitney Bowes Inc.

Mail and other media, hereinafter collectively and individually referred to as documents, are received or created at block 34 and certain of these received/created documents are retained at block 36 depending upon the needs and application of the recipient and the organization in which they are operating. At block 37 retained document attribute sensors sense the attributes of documents filed in the retained document filing arrangement. The retained document attribute sensors can be arranged and employed as described herein to provide attribute data as to retained documents and files housed in the retained document filling arrangement.

At 38 several alternative document processing channels 40, 42, 44, 46 and 48 are available. These are representative document processing channels and other types of document processing channels can be employed. Document processing channel 40 includes filing the documents in cabinets which are indexed at a document level at block 50. At block 52 the documents are maintained through various activities associated with physically filed documents such as retrieval, movement and the like. After a period of time a determination is made to box the files and store boxes at block 54. These are indexed at the box level. Box files also require maintenance in terms of movement, retrieval and the like as depicted at block 56. Finally at the end of the use for life of the documents they are disposed of at block 58. In like manner, channel 42 involves the filing of documents in file cabinets but these documents are indexed at the file level at block 60. The documents at block 60 in the file cabinets likewise required to be maintained at block 62 and then progress as in channel 40 for the files to be boxed and stored and indexed at a box level as depicted in block 54. A third document processing channel is depicted at 44 and involves the filing of documents in file cabinets at block 64 with no further activity until the documents are moved to a further document processing channel 46 or 48. Both document processing channels 46 and 48 involves scanning. It should be noted that the documents to be retained rather than filed in filing cabinets can be immediately scanned in either channel 46 or channel 48. Various scanning arrangements can be employed. One scanning arrangement is disclosed in U.S. Pat. No. 7,161,108 B2 for SYSTEM AND METHOD FOR ROUTING IMAGED DOCUMENTS filed Mar. 11, 2003 and assigned to Pitney Bowes Inc.

Referring now to channel 46, at block 66 the documents are scanned and at block 68 the documents are digitized and indexed at a document level. Thereafter, at block 70 the digitized documents are stored as digitized data at a service and at block 72 are maintained by the service. Finally the digitized stored documents are disposed of at block 74 at the end of the documents useful life. Finally, at channel 48 the incoming documents from the filing cabinets in channel 44 are scanned at block 76 and thereafter are digitized and indexed at a file level at block 78. The digitized index documents are stored as digitized data as in house at block 80 and maintained in house at block 82. Finally, at the end of the useful life of the digitized stored data documents they are disposed of at block 84. It should be noted that cross over in document processing channels 46 and 48 can occur as shown with digitized data stored at a service or in-house.

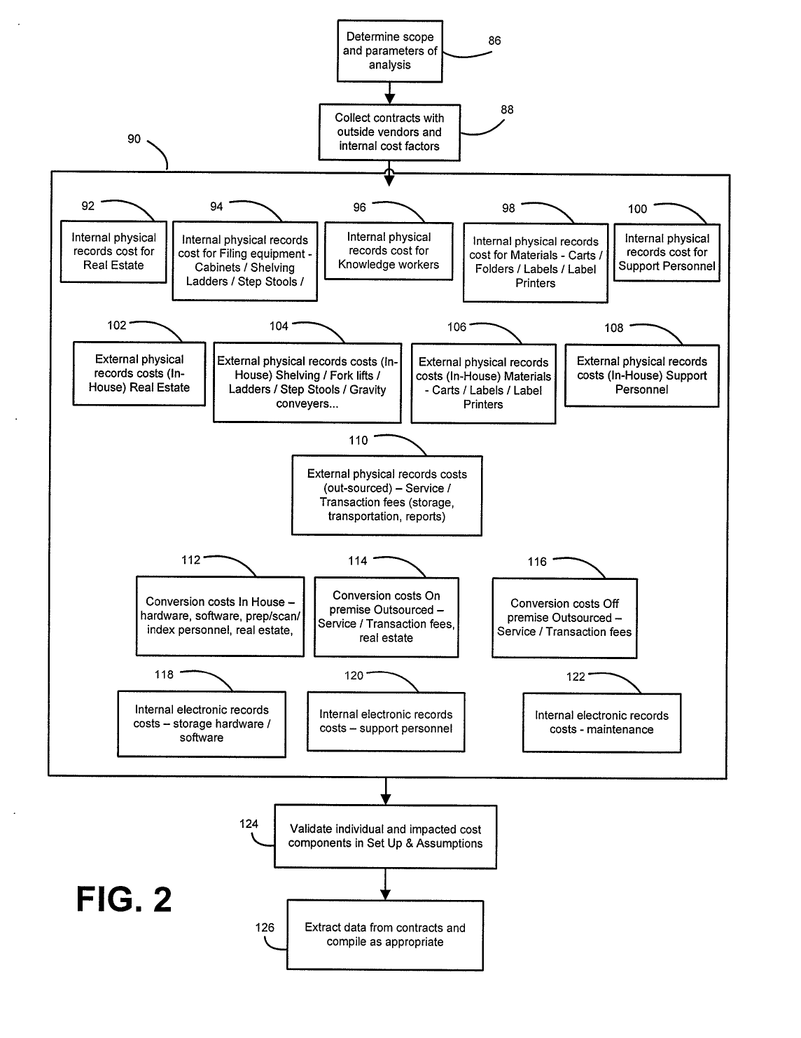

Reference is now made to FIG. 2. Various data inputs are organized for use in the system of the present invention at block 86 where the scope and parameters of analysis are determined. These can vary depending on the nature of the organization providing the input data. At block 88 contracts with outside vendors and internal cost factors are collected. The cost factors include the various items shown within box 90. These factors can be internal cost factors such as internal physical record cost for real estate at block 92 internal physical records costs for filing equipment, cabinets, shelving, ladders, step stools and the like at block 94. Internal physical record costs for knowledge workers as shown at block 96. Internal physical cost for materials, carts, folders, labels, and printers as shown in block 98. Internal physical cost for support personnel as shown at block 100. There are costs associated with external storage and these include external physical record costs including in-house and real estate costs at block 102 external physical records cost in-house shelving, forklifts, ladders, step stools, gravity conveyors and the like at block 104. External physical records cost in-house materials cost, labels and label printers at block 106. External physical records cost in-house support personnel at block 108. Thus, blocks 102, 104, 106 and 108 reflect external costs that are born by the in-house operation which rents these facilities or uses these facilities as opposed to storing records physically in-house. They are offsite direct cost to the storage of the records.

Finally external physical records cost outsourced includes service transaction fees, storage transportation and reports at block 110. The conversion of physical records to electronic records can occur in-house. Conversion the costs include hardware, software, preparation, scanning, indexing, personnel, and real estate as shown at block 112. Conversion costs on premises can also be by outsourced personnel and include transaction fees and real estate costs as depicted at block 114. The conversion can be fully outsourced and the conversion costs off site premises outsourced include service and transaction fees at block 116. Finally internal records costs include storage, hardware and software as shown at block 118. Internal electronic records cost and support personnel as shown at block 120. Internal electronic records cost maintenance of the hardware and software as shown at block 122. Once all of the data noted above is gathered the data is validated at block 124 where the gathered data is validated individually and cost components inspected with respect to the initial set up and assumptions in gathering the data. At block 126 data is extracted from contracts and compiled as appropriate.

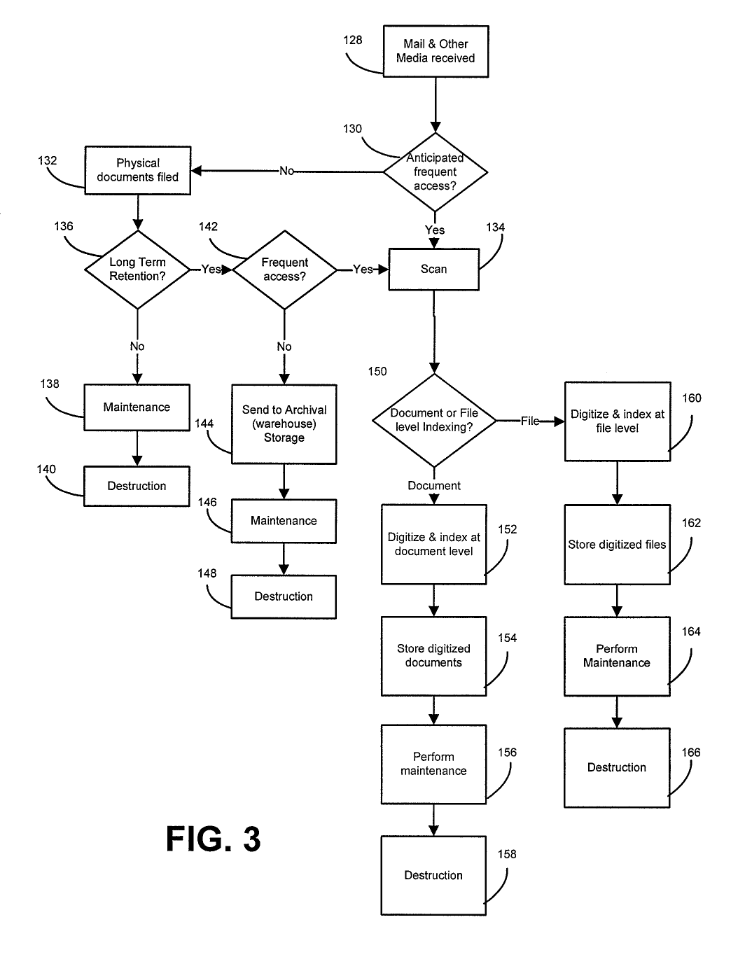

Reference is now made to FIG. 3. FIG. 3 is a flow chart of the analysis of the alternative document processing channels. The process begins at block 128 where mail and other media are received. A determination is made at decision block 130 whether frequent access is anticipated where that is not the case the process continues at block 132 where physical documents are filed. If frequent access is anticipated, the process continue at block 134. Referring to the physical documents filed at decision block 136, a further determination is made at block 136 whether long term retention is needed. If this is not the case, the documents are maintained at block 138 in physical format and at the end of a useful life destroyed at block 140. Where long term retention is anticipated at decision block 136, a further determination is made at decision block 142 whether the access to the documents will be frequent. If this is the case, the process continues at previously noted block 134 where scanning occurs. However, if this is not the case, the documents are sent to archival warehouse storage at block 144. The documents in archival storage are maintained at block 146 and at the end of their useful life are destroyed at block 148.

Where scanning occurs at block 134, a determination is made at decision block 150 whether the documents that are scanned should be indexed at the document or file level. Where the documents are indexed at the document level, the process continues with the documents being digitized and indexed at the document level at block 152 and digitized documents stored at block 154. Maintenance is performed on the digitized stored documents at block 156 and the documents are destroyed at the end of their useful life at block 158.

Referring again to decision block 150, where the indexing is at the file level, the process continues at block 160 where the documents are digitized and indexed at the file level. Thereafter the digitized files are stored at block 162 and maintenance is performed at block 164. The stored digitized files are destroyed at block 166 at the end of their useful life.

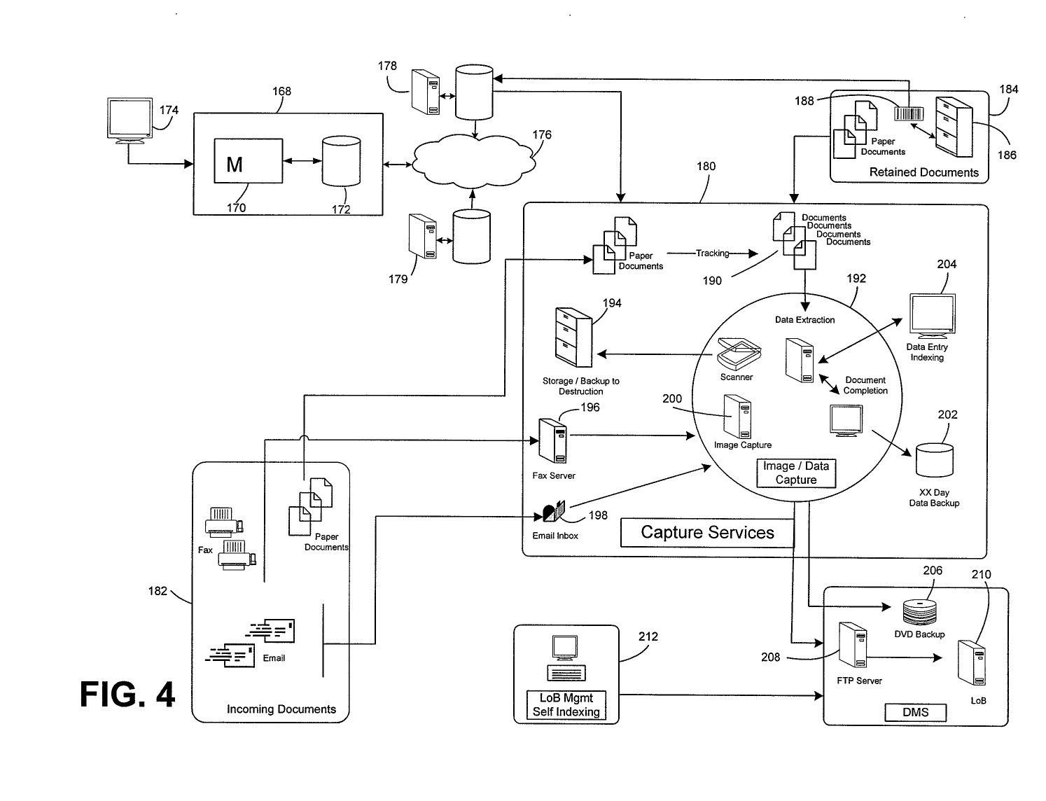

Reference is now made to FIG. 4. Computer 168 includes a microprocessor 170 for implementing the various calculations described above and includes a memory device 172 for storing data and applications. A display 174 provides the results to the user to review in terms of various data input and various analyses effectuated. In one embodiment the computer 168 is connected to a network 176, such as the internet, which is in connection with further data sources and controllers such as 178 and 179. Controllers 178 is part of the system of a particular document processing channel which includes the capture and scanning of documents where document images are ingested and indexed as part of the workflow. Other document processing channels can be connected to the computer 168 by means of network 176. The capture services as shown at 180 have various inputs to the service where this is the document processing channel being implemented. This includes incoming documents shown generally at 182 and also can include facsimile, email and paper documents. All of which are to be processed by the capture services. Another source of documents to be processed by the captured services 180 are retained documents shown generally at 184 and these can consist of documents and files of various sorts.

The retained documents are files in a retained document filing arrangement 186 connected to retained document sensors 188. The retained document attribute sensors are connected to the controller 178 and through the network 176 to the computer 168. Different organizations of the hardware may be employed to communicate the sensed retained document attribute data to the computer 168.

The document capture services 180 take the paper documents at 190 from whatever source they may come and tracks the documents for handling purposes. This tracking captures the various stations at which the documents have been processed. The documents then enter the data extraction process at 192 where they are scanned and stored in an image capture server for later and further storage. The physical documents after being scanned and stored are then moved to a physical back up storage 194 for to thereafter be destroyed when a suitable time has passed such as to allow time for quality control of the scanned documents and a determination that the process has been successful. Other sources of image capture include the fax documents which go from the fax server 196 directly to the image capture process and the email inbox depicted at 198 which also goes directly to the image capture service without the need for scanning. At this point all of the images and data from the various sources have been ingested and captured at server 200. The captured images are backed up for disaster recovery and back up in storage 202. A further computer 204 may be provided to allow an operator to monitor the process and index data where required. External indexing of data can occur by employing computer 204 which is external to the image/data extraction process.

Subsequent to the capture services being completed, the captured images are backed up on a DVD or other medium 206 for use by the document owner and can be transferred to a file transfer protocol server 208. The file transfer protocol server 208 processes the data to the format suitable for use by the user designated as a Line of Business (LOB) operation at 210. The line of business management can determine to access the data and provide self indexing of the image/data capture and stored on the server 210 as denoted generally at 212.

While the present invention has been described in connection with what is presently considered to be the most practical and preferred embodiments, it is to be understood that the invention is not limited to the disclosed embodiment, but, on the contrary, is intended to cover various modifications and equivalent arrangements included within the spirit and scope of the appended claims.

What is claimed is:

1. A system for enhancing the storage and retrieval of documents, the system comprising:
a retained document filing arrangement to receive documents to be retained, the retained document filing arrangement including sensors configured to detect sensed attributes of documents filed in the retained document filing arrangement;
a controller computer in communications with the retained document filing arrangement sensors and configured to receive sensed attributes of documents filed in the retained document filing arrangement, the controller computer including a memory storage device configured to receive and store attribute data regarding attributes of documents filed in the retained document filing arrangement, the memory storage device further including data correlating particular filed document attributes corresponding to stored attributes of one or more document processing channels, the controller computer programmed to compare filed document attributes by processing filed document sensed attributes and stored document processing channel attributes to determine similarities of sensed document attributes and stored document processing channel attributes; and,
wherein the memory storage device for the controller computer includes document processing channel recommendations corresponding to the filed documents in the retained document filing arrangement and the controller computer is programmed to present those document processing channel recommendations to a user based on filed document sensed attributes and stored document processing channel attributes.

2. The system of claim 1 wherein one of the document processing channels is a channel with scanning, digitizing and indexing of retained documents.

3. The system of claim 2 wherein the indexing of retained documents is at the document level.

4. The system of claim 2 wherein the indexing of retained documents is at the file level.

5. The system of claim 2 wherein one of the document processing channels is a channel with documents in cabinets indexed at the document level.

6. The system of claim 2 wherein one of the document processing channels is a channel with documents in file cabinets indexed at the file level.

7. A computer implemented method of enhancing the storage and retrieval of documents, the method comprising:
inputting information about documents filed in a retained document filing arrangement, the information including data regarding the volume of documents in the retained document filing arrangement and frequency of access to the documents filed in the retained document filing arrangement;
inputting information about document processing channels, the information including data relating to document preparation for filing, filed document maintenance, filed document access and filed document retrieval;
comparing the input information about documents filed in the retained document filing arrangement and the input information about document processing channels to determine similarities of input information about filed documents and input information about document processing channels; and,
wherein the comparing step comprises correlating document processing channel attributes with filed document attributes, and wherein the comparing step further include recommending a document processing channel to a user whereby a document processing channel implementation is facilitated that enhances the further storage and retrieval of documents filed in the retained document filing arrangement.

8. The method of claim 6 wherein information about the document processing channels further includes data relating to filed document destruction.

9. The method of claim 6 wherein sensors are connected to the retained document filing arrangement and the input information about documents filed in a retained document filing arrangement is from the sensors.

10. The method of claim 6 wherein one of the document processing channels is a channel with scanning, digitizing and indexing of retained documents.

11. The method of claim 9 wherein the indexing of retained documents is at the document level.

12. The system of claim 9 wherein the indexing of retained documents is at the file level.

13. The system of claim 9 wherein one of the document processing channels is a channel with documents in cabinets indexed at the document level.

14. The system of claim 9 wherein one of the document processing channels is a channel with documents in file cabinets indexed at the file level.
